(19) United States
(12) Patent Application Publication
(10) Pub. No.: US 2026/0182496 A1
(43) Pub. Date: Jul. 2, 2026

(54) HAND-PUSHED MOWER

(71) Applicant: Lawnix Technology (Nanjing) Co., Ltd., Nanjing (CN)

(72) Inventor: Xiaoke Zou, Nanjing (CN)

(21) Appl. No.: 19/241,911

(22) Filed: Jun. 18, 2025

(30) Foreign Application Priority Data
Dec. 26, 2024 (CN) 202411944614.5

(51) Int. Cl. A01D 34/74; A01D 34/68; A01D 101/00

(52) U.S. Cl. CPC A01D 34/74; A01D 34/68; A01D 2101/00

(57) ABSTRACT

A hand-pushed mower is provided. The hand-pushed mower includes a body, a leveling member, a body height adjusting member, a shifting plate, a front wheel assembly, a rear wheel assembly, and a cutting member. The rear wheel assembly includes a rotating shaft and rear wheels arranged in a pair, two ends of the rotating shaft are connected to the rear wheels respectively, the rotating shaft is connected to the body through two assembly points, a line segment between the two assembly points constitutes a first axis, a line segment between circle centers of the rear wheels constitutes a second axis, the first and the second axes are not coaxial, the shifting plate includes a main body part and a supporting part, the main body part is connected to the body, and the leveling member is arranged at the supporting part and in direct contact with the ground.

### CROSS-REFERENCE TO RELATED APPLICATIONS

The present application claims priority to Chinese Patent Application No. 202411944614.5, filed with the China National Intellectual Property Administration on Dec. 26, 2024 and entitled “HAND-PUSHED MOWER”, which is incorporated herein by reference in its entirety.

### TECHNICAL FIELD

The present application belongs to the technical field related to mowers, and specifically relates to a hand-pushed mower.

### BACKGROUND

In the conventional technology, a holding rod of a mower is folded through a shifting plate, such that a body occupies the smallest space. In addition, the body is kept upright through a supporting structure of the shifting plate, such that the body occupies a smaller area and is convenient to store. This design makes it easier to store the mower in an environment with limited space, such as a garage or a tool room. However, with use of a body height adjusting member, a user can flexibly adjust a height of the mower to adapt to different lawn conditions and personal preferences. This causes several potential problems as follows.

After the body height adjusting member of the mower is adjusted, a center of gravity of the entire apparatus probably rises. Due to such a height change, the mower is more likely to lose its balance in a vertical or near-vertical storage state. Moreover, a side force or uneven external disturbance applied to a storage zone of the mower increases a probability that the height-increased body that is vertically stored is displaced and eventually tips over. Meanwhile, ground conditions are diversified after the body is upright. When the ground is uneven in some cases, flatness of a position at which the shifting plate makes contact with the ground generally varies. Consequently, an actual contact area between the shifting plate and the ground is relatively small, and a contact point of the mower possibly is not in full contact with the ground, thus weakening an overall supporting capability of the mower. After the body height adjusting member is adjusted, the center of gravity of the entire apparatus may become higher. Such an effect is more exacerbated if projections or dimples appear irregularly on the ground. In addition, during production, assembly, and use of the mower, asymmetry on two sides of the shifting plate may be caused by manufacturing and assembly errors, or assembly errors of vibration looseness may be caused by failure to maintain the shifting plate in time after use. These errors will cause an imbalance of the shifting plate and rear wheels when they are in contact with the ground. The imbalance is manifested as shaking of the body. After height adjustment, the imbalance is more obvious as the center of gravity changes. The instability increases a risk of inclining or overturning. In addition, the instability further causes a possibility of scuffing and abrading the ground.

Thus, it is necessary to improve the conventional technology to overcome defects in the conventional technology.

### SUMMARY

Thus, the present application aims to solve a technical problem of poor standing stability of a mower.

To solve the technical problems, a hand-pushed mower is provided according to an aspect of the present application. The hand-pushed mower includes a body, a leveling member, a body height adjusting member, a shifting plate, a front wheel assembly, a rear wheel assembly, and a cutting member. The rear wheel assembly includes a rotating shaft and rear wheels arranged in a pair. Two ends of the rotating shaft are connected to the rear wheels respectively. The rotating shaft is assembled at the body. The rotating shaft is connected to the body through two assembly points. A line on which a line segment between the two assembly points is located constitutes a first axis. A line on which a line segment between circle centers of the rear wheels is located constitutes a second axis. The first axis and the second axis are not coaxial. The body height adjusting member operates at two or more levels. The body height adjusting member is configured to drive the rear wheels to rotate around the first axis so as to adjust a height of the body. The shifting plate is configured to keep the body upright when a holding rod of the body is folded and the body is in a storage state. The shifting plate includes a main body part and a supporting part. The main body part is connected to the body. The leveling member is arranged at the supporting part and is configured to be in direct contact with ground. When the body is in an upright state, the rear wheels are tangent to the ground. When the body height adjusting member is at a lowest level, a tangent line of a corresponding one of the rear wheels located at one side of the rear wheels away from the front wheel assembly and passing through a preset point W of the leveling member is L1. When the body height adjusting member is at a highest level, a tangent line of the corresponding rear wheel located at one side of the rear wheels away from the front wheel assembly and passing through the preset point W of the leveling member is L2. An included angle β between the tangent line L1 and the tangent line L2 is an acute angle. Axes of the rear wheels and the rotating shaft are not coaxial, such that the body height adjusting member may drive the rear wheels to rotate to adjust the height of the body. In addition, the included angle β between the tangent lines L1 and L2 of the corresponding rear wheel located at the side of the rear wheels away from the front wheel assembly and passing through the preset point W of the leveling member at the lowest level and at the highest level respectively is the acute angle, such that when the body is stored vertically, the body has a sufficiently wide and stable low surface at each level, so as to resist slight vibration or external impact, and meanwhile, a change of an angular relationship between the rear wheels and the supporting part at each level is controlled to float within a small angle range. Mechanical performance of the body is improved by optimizing a supporting structure and geometrical parameters. A problem of fluctuation of a center of gravity caused by an architectural change in a mechanical movement process is better solved. Thus, reliable defense of the apparatus is ensured even if the apparatus encounters complex external factors, and overall anti-tipping performance is improved. In this way, the mower may be stored vertically in a more secure and stable manner. In addition, the leveling member is arranged at the supporting part, the leveling member may adapt to different landforms and provide optimal support for the body, and standing stability of the body at any level is ensured through coordination of positions of the rear wheels. Meanwhile, ground abrasion caused by friction may be effectively reduced. An additional damping effect is further provided to disperse pressure of the supporting part. Stability of the body is further enhanced, and potential shaking or overturning of the body in the upright state is eliminated.

In an embodiment, at least part of the leveling member is in contact with the ground at one or more of the two or more levels. Hardness of the leveling member is less than that of the supporting part. Through the arrangement, the leveling member may better adapt to a tiny irregular surface, such that an attaching effect of the uneven ground and the device when the entire device is mounted is improved, and imbalance of the shifting plate and the rear wheels making contact with the ground is reduced. In addition, the leveling member may absorb some forces in a case that a side force or uneven external disturbance is applied. Thus, imbalance between the shifting plate and the rear wheels making contact with the ground is reduced, and the problem of scuffing and abrading the ground by the shifting plate during shaking is avoided.

In an embodiment, in the upright state, a line segment constituted by a contact point between the leveling member and the ground and a contact point between the corresponding rear wheel and the ground is L, and a distance between an intersection point of a vertical line on which a center of gravity of the body is located and the line segment L and a midpoint of the line segment L is less than or equal to ±150 mm. Through the arrangement, the body may be kept in a desirable standing state at each level, potential shaking or overturning of the body in the upright state is eliminated, and the body may have relatively high standing stability at each level.

In an embodiment, the included angle β is less than or equal to 15°. Through the arrangement, the body has as small an angular deviation as possible at each level, an excessive deviation angle of the center of gravity of the body is avoided, and it is ensured that the body may have high standing stability at each level.

In an embodiment, a size of each of the rear wheels is identical to that of a front wheel of the front wheel assembly, and a rotation angle θ of each of the rear wheels satisfies: 90°≤θ≤270°. A distance between the second axis and the first axis is greater than or equal to a vertical distance between a lowest cutting plane of the hand-pushed mower at the highest level of the body height adjusting member and that of the hand-pushed mower at the lowest level of the body height adjusting member. Alternatively, a size of each of the rear wheels is greater than or equal to that of a front wheel of the front wheel assembly, and a rotation angle θ of each of the rear wheels satisfies: 90°<θ<270°. A distance between the second axis and the first axis is greater than a vertical distance between a lowest cutting plane of the hand-pushed mower at the highest level of the body height adjusting member and that of the hand-pushed mower at the lowest level of the body height adjusting member. The lowest cutting plane is a cutting plane of the cutting member during cutting at the lowest level. Through the arrangement, it is ensured that when the shifting plate and the rear wheels support the body to stand upright, and the change of the angular relationship between the rear wheels and the supporting part at each level is controlled to float within the small angle range, a backward deviation angle of the center of gravity is smaller, and an angle between the shifting plate and the ground is smaller when the body is laid flat. Thus, the body is more compact, a product packaging height is shortened, and production cost is reduced.

In an embodiment, a radius size of each of the rear wheels is 20 mm greater than a distance between the second axis and the first axis.

In an embodiment, the supporting part and the main body part are arranged with an included angle formed therebetween. Through the arrangement, the supporting part and the main body part are arranged in an L-shaped bending manner, such that one side, closer to the ground, of the leveling member arranged at the supporting part is provided with a large surface, a large contact area is achieved, and contact stability with the ground is improved.

In an embodiment, the supporting part and the main body part are arranged at an identical plane or at parallel planes. Through the arrangement, a contact area between the shifting plate and the ground may be reduced. Thus, a contact area between the leveling member and the ground is relatively small, such that ground abrasion is reduced as much as possible.

In an embodiment, the main body part or the supporting part is provided with an assembly port, and the assembly port is a closed port or an opened port. By providing the assembly port, firm connection between the leveling member and the shifting plate may be ensured.

In an embodiment, the assembly port is located at the main body part, or the assembly port is located at the supporting part and the supporting part and the main body part are arranged at an identical plane or at parallel planes, the assembly port is the closed port, and a minimum distance h between one side of the assembly port closer to the ground in the upright state and an outermost edge, close to the ground, of the supporting part is greater than 2 mm. Through the arrangement, the assembly port may not only prevent local stress concentration caused by an irrational design during assembly and use, but also avoid damage to overall strength of the supporting part, thus ensuring long-term durability and stability of the supporting part.

In an embodiment, the supporting part and the main body part are arranged with an included angle formed therebetween, and the assembly port is located at the supporting part. The assembly port is the closed port, and a minimum distance h between a periphery of the assembly port and an outer periphery of the supporting part is greater than 2 mm. Through the arrangement, the assembly port may not only prevent local stress concentration caused by an irrational design during assembly and use, but also avoid damage to overall strength of the supporting part, thus ensuring long-term durability and stability of the supporting part.

In an embodiment, the shifting plate further includes a fastener. The leveling member is fixed to the supporting part through the assembly port and the fastener. With the fastener, the leveling member may be firmly fixed to the supporting part. Thus, the leveling member is prevented from falling off as much as possible, and unnecessary maintenance and replacement are reduced.

In an embodiment, the main body part or the supporting part is provided with a positioning member, the leveling member is provided with a matching member, and the matching member is connected to the positioning member in a clamping manner, such that the leveling member is arranged around the supporting part. Through the arrangement, the leveling member and the supporting part may be fixed to each other in a clamping and matching manner, such that connection stability is improved.

In an embodiment, the leveling member is provided with a recess, and a minimum distance between any one group of opposite faces in the leveling member is less than a thickness of the supporting part, such that the leveling member is arranged around the supporting part. Alternatively, a clamping member is arranged at an inner wall of a recess, and a minimum distance between any one group of opposite faces of the leveling member is less than a thickness of the supporting part, such that the leveling member is arranged around the supporting part. Through the arrangement, the leveling member is arranged in a U-shaped structure having two sides bent inward, so as to be arranged around the supporting part and tightly clamp the supporting part without other fixing structures, which is simple and convenient. With the clamping member, connection firmness between the leveling member and the supporting part may be further improved.

In an embodiment, a first end of the leveling member is arranged around the supporting part, a second end of the leveling member extends from the supporting part to the main body part, the shifting plate further includes a fastener, and one or two ends of the leveling member are fixed to the shifting plate through the assembly port and the fastener. Through the arrangement, an end of the leveling member may be firmly fixed to the shifting plate, such that connection stability is ensured.

In an embodiment, the fastener includes a screw. The leveling member is provided with an assembly hole corresponding to the assembly port, and the screw is configured to penetrate the assembly port and extend into the assembly hole to be fixed to the leveling member. The screw may be stably and firmly connected to the leveling member, and further connection stability of the leveling member and the shifting plate is improved.

In an embodiment, the leveling member is provided with a protrusion, an end of the protrusion is a clamping end, and the protrusion is configured to penetrate the assembly port and is connected to the supporting part in a clamping manner. Through the arrangement, the clamping end of the protrusion may penetrate the assembly port so as to be clamped and stopped by an inner side surface of the supporting part, such that the leveling member is stably and firmly connected to the supporting part.

In an embodiment, two ends of the leveling member are provided with a first locking part and a second locking part respectively, and at least one of the first locking part and the second locking part is locked to the assembly port. Through the arrangement, the two ends of the leveling member may be locked to the shifting plate, and connection stability of the leveling member and the shifting plate is ensured.

In an embodiment, the leveling member is provided with a recess, such that the leveling member is arranged around the supporting part. Each of two ends of the leveling member is provided with a via hole corresponding to the assembly port. The shifting plate further includes a fastener. The fastener is configured to penetrate the two via holes and the assembly port, such that the leveling member is fixed to the supporting part. The connection method between the fastener and the via holes as well as the assembly port may ensure connection stability of the leveling member and the supporting part.

In an embodiment, each of two ends of the leveling member is provided with a snap-fitting structure, and the snap-fitting structure is fixed to an edge of the supporting part in a clamping manner. Through the arrangement, the two ends of the leveling member may be clamped to and limited by the supporting part, such that connection stability of the leveling member and the supporting part is ensured.

In an embodiment, the leveling member is provided with an accommodating recess and a via hole, the via hole is in communication with the accommodating recess, an end of the supporting part is adaptively accommodated in the accommodating recess, the supporting part is provided with an assembly port, the shifting plate further includes a fastener, and the fastener is configured to penetrate the via hole and the assembly port to be fixed to the supporting part. The connection method between the fastener and the via holes as well as the assembly port may ensure connection stability of the leveling member and the supporting part.

In an embodiment, the supporting part is provided with an accommodating recess and the assembly port, the assembly port is in communication with the accommodating recess, an opening of the accommodating recess is located away from the body, the leveling member is accommodated in the accommodating recess, the shifting plate further includes a fastener, and the fastener is configured to penetrate the assembly port to be fixed to the leveling member.

In an embodiment, the shifting plate is made of a hard material.

In an embodiment, the shifting plate is made of a metal material.

In an embodiment, the leveling member is made of a flexible material.

In an embodiment, the flexible material includes at least one of plastic, silica gel, rubber, teflon, foamed polyurethane, a polyurethane elastomer, or flexible polyurethane. The above materials ensure that the leveling member have wear resistance in addition to flexibility, and ensure the service life.

In an embodiment, the leveling member is of a solid structure. Alternatively, the leveling member is of a hollow structure. Alternatively, the leveling member is provided with a hollow cavity, and multiple supporting columns are arranged at intervals in the hollow cavity. The solid structure ensures that the leveling member is in full and firm contact with the ground. The hollow structure may play a further buffering role, such that the leveling member may make contact with the ground more flexibly, and manufacturing cost of the leveling member may be saved. The supporting columns may more fully transfer gravity of the body to the ground while playing a buffering role in the hollow cavity, such that the body is ensured to be in full contact with the ground, and the body is firmly kept in the upright state.

In an embodiment, the supporting part is detachably connected to the main body part. Alternatively, the supporting part and the main body part are integrally formed. Through integral forming, the shifting plate may be ensured to have sufficient structural strength, thus prolonging the service life. Through detachable connection, when the shifting plate needs to be maintained and replaced, only the corresponding supporting part or main body part needs to be replaced, and the entire shifting plate does not need to be replaced, such that operation of the maintenance personnel is facilitated, and maintenance cost is reduced.

In an embodiment, the leveling member is bonded to the supporting part. In this way, the leveling member may be directly fixed to the supporting part without other structural parts, which is convenient and fast.

In an embodiment, the supporting part is of at least one single shape or a combined shape of an I-shape, a J-shape, an L-shape, a T-shape, a shape of two parallel horizontal bars with a vertical bar across the two parallel horizontal bars, a C-shape, or a U-shape. Through the arrangement, the supporting part may adapt to different connection methods.

In an embodiment, one side of the leveling member closer to the ground is of a flat surface, an arc-shaped surface, a trapezoidal surface, or a sharp-pointed structure. Through the arrangement, the leveling member may adapt to different levels of the body height adjusting member.

In an embodiment, in the upright state, an included angle α between the body and a vertical direction ranges from 0° to 20°.

In an embodiment, when the body is in the upright state, the leveling member is in line contact with the ground at any one of the two or more levels. Through the arrangement, a contact area between the leveling member and the ground may be reduced, and the problem of scuffing and abrading the ground may be avoided as much as possible.

In an embodiment, when the body is in the upright state, the leveling member is in surface contact with the ground at any one of the two or more levels. Through the arrangement, at any one of the two or more levels, the leveling member has a certain area to make contact with the ground, thus ensuring contact stability with the ground.

In an embodiment, a contact position between the leveling member and the ground changes with a change between the two or more levels under an effect of the body height adjusting member. Through the arrangement, the leveling member may provide optimal support for the body at any level, and through coordination of positions of the rear wheels, such that standing stability of the body at any level is ensured.

In an embodiment, the supporting part is rotatably connected to the main body part, and the leveling member is located at one side of the supporting part away from the main body part. With the supporting part in a rotatable manner, the leveling member arranged at the supporting part may always be in surface contact with the ground along with gravity, such that the contact area between the leveling member and the ground is increased, and contact stability with the ground is improved.

A hand-pushed mower is provided according to another aspect of the present application. The hand-pushed mower includes a body, a body height adjusting member, a shifting plate, a front wheel assembly, a rear wheel assembly, and a cutting member. The rear wheel assembly includes a rotating shaft and rear wheels arranged in a pair. Two ends of the rotating shaft are connected to the rear wheels respectively. The rotating shaft is assembled at the body. The rotating shaft is connected to the body through two assembly points. A line on which a line segment between the two assembly points is located constitutes a first axis. A line on which a line segment between circle centers of the rear wheels is located constitutes a second axis. The first axis and the second axis are not coaxial. The body height adjusting member operates at two or more levels. The body height adjusting member is configured to drive the rear wheels to rotate around the first axis so as to adjust a height of the body. The shifting plate is configured to keep the body upright when a holding rod of the body is folded and the body is in a storage state. The shifting plate includes a main body part and a supporting part. The main body part is connected to the body. The supporting part is configured to be in direct contact with ground. When the body is in an upright state, the rear wheels are tangent to the ground. When the body height adjusting member is at a lowest level, a tangent line of a corresponding one of the rear wheels located at one side of the rear wheels away from the front wheel assembly and passing through a preset point W of the supporting part is L1. When the body height adjusting member is at a highest level, a tangent line of the corresponding rear wheel located at one side of the rear wheels away from the front wheel assembly and passing through the preset point W of the supporting part is L2. An included angle β between the tangent line L1 and the tangent line L2 is an acute angle.

In an embodiment, in the upright state, a line segment constituted by a contact point between the supporting part and the ground and a contact point between the corresponding rear wheel and the ground is L, and a distance between an intersection point of a vertical line on which a center of gravity of the body is located and the line segment L and a midpoint of the line segment L is less than or equal to ±150 mm. Through the arrangement, the body may be kept in a desirable standing state at each level, potential shaking or overturning of the body in the upright state is eliminated, and the body may have relatively high standing stability at each level.

In an embodiment, the included angle β is less than or equal to 15°. Through the arrangement, the body has as small an angular deviation as possible at each level, an excessive deviation angle of the center of gravity of the body is avoided, and it is ensured that the body may have high standing stability at each level.

In an embodiment, a size of each of the rear wheels is identical to that of a front wheel of the front wheel assembly, and a rotation angle θ of each of the rear wheels satisfies: 90°≤θ≤270°. A distance between the second axis and the first axis is greater than or equal to a vertical distance between a lowest cutting plane of the hand-pushed mower at the highest level of the body height adjusting member and that of the hand-pushed mower at the lowest level of the body height adjusting member. Alternatively, a size of each of the rear wheels is greater than or equal to that of a front wheel of the front wheel assembly, and a rotation angle θ of each of the rear wheels satisfies: 90°<θ<270°. A distance between the second axis and the first axis is greater than a vertical distance between a lowest cutting plane of the hand-pushed mower at the highest level of the body height adjusting member and that of the hand-pushed mower at the lowest level of the body height adjusting member. The lowest cutting plane is a cutting plane of the cutting member during cutting at the lowest level. Through the arrangement, it is ensured that when the shifting plate and the rear wheels support the body to stand upright, and the change of the angular relationship between the rear wheels and the supporting part at each level is controlled to float within the small angle range, a backward deviation angle of the center of gravity is smaller, and an angle between the shifting plate and the ground is smaller when the body is laid flat. Thus, the body is more compact, a product packaging height is shortened, and production cost is reduced.

In an embodiment, a radius size of each of the rear wheels is 20 mm greater than a distance between the second axis and the first axis.

The technical solution according to the embodiments of the present application has the following advantages.

The hand-pushed mower according to the embodiments of the present application includes the body, the leveling member, the body height adjusting member, the shifting plate, the front wheel assembly, the rear wheel assembly, and the cutting member. The rear wheel assembly includes the rotating shaft and the rear wheels arranged in a pair. The two ends of the rotating shaft are connected to the rear wheels respectively. The rotating shaft is assembled at the body. The rotating shaft is connected to the body through the two assembly points. The line on which the line segment between the two assembly points is located constitutes the first axis. The line on which the line segment between the circle centers of the rear wheels is located constitutes the second axis. The first axis and the second axis are not coaxial. The body height adjusting member operates at two or more levels. The body height adjusting member is configured to drive the rear wheels to rotate around the first axis so as to adjust the height of the body. The shifting plate is configured to keep the body upright when the holding rod of the body is folded and the body is in the storage state. The shifting plate includes the main body part and the supporting part. The main body part is connected to the body. The leveling member is arranged at the supporting part and is configured to be in direct contact with the ground. When the body is in the upright state, the rear wheels are tangent to the ground. When the body height adjusting member is at the lowest level, the tangent line of the corresponding one of the rear wheels located at the side of the rear wheels away from the front wheel assembly and passing through the preset point W of the leveling member is L1. When the body height adjusting member is at the highest level, the tangent line of the corresponding rear wheel located at the side of the rear wheels away from the front wheel assembly and passing through the preset point W of the leveling member is L2. The included angle β between the tangent line L1 and the tangent line L2 is the acute angle. In this way, the axes of the rear wheels and the rotating shaft are not coaxial, such that the body height adjusting member may drive the rear wheels to rotate to adjust the height of the body. In addition, the included angle β between the tangent lines L1 and L2 of the corresponding rear wheel located at the side of the rear wheels away from the front wheel assembly and passing through the preset point W of the leveling member at the lowest level and at the highest level respectively is the acute angle, such that when the body is stored vertically, the body has a sufficiently wide and stable bottom surface, so as to resist slight vibration or external impact, and meanwhile, the change of the angular relationship between the rear wheels and the supporting part at each level is controlled to float within the small angle range. The mechanical performance of the body is improved by optimizing the supporting structure and the geometrical parameters. The problem of fluctuation of the center of gravity caused by the architectural change in the mechanical movement process is better solved. Thus, the reliable defense of the apparatus is ensured even if the apparatus encounters the complex external factors, and the overall anti-tipping performance is improved. In this way, the mower may be stored vertically in a more secure and stable manner. In addition, the leveling member is arranged at the supporting part, the leveling member may adapt to different landforms and provide optimal support for the body, and standing stability of the body at any level is ensured through coordination of the positions of the rear wheels. Meanwhile, the ground abrasion caused by the friction may be effectively reduced. The additional damping effect is further provided to disperse the pressure of the supporting part. The stability of the body is further enhanced, and the potential shaking or overturning of the body in the upright state is eliminated. A problem of poor standing stability of a mower in the conventional technology is solved.

### BRIEF DESCRIPTION OF THE DRAWINGS

To more clearly illustrate technical solutions in specific implementations of the present application or in the conventional technology, the accompanying drawings required for description of the specific implementations or the conventional technology will be briefly introduced below. Apparently, the accompanying drawings in the following description illustrate some implementations of the present application, and those of ordinary skill in the art can still derive other drawings from these accompanying drawings without any creative effort.

FIG. 1 is a schematic structural diagram of a solid diagram of an upward view of a hand-pushed mower provided by a specific embodiment of the present application;

FIG. 2 is a schematic structural diagram of a hand-pushed mower provided by a specific embodiment of the present application at a level in an upright state;

FIG. 3 is a partial enlarged view of the leveling member in FIG. 2;

FIG. 4 is a schematic structural diagram of a hand-pushed mower provided by a specific embodiment of the present application at another level in an upright state;

FIG. 5 is a schematic structural diagram of connection between a body and a rear wheel assembly provided by a specific embodiment of the present application;

FIG. 6 is a schematic diagram of a plurality of levels of a hand-pushed mower provided by a specific embodiment of the present application;

FIG. 7 is a schematic diagram of a first level of a hand-pushed mower provided by a specific embodiment of the present application;

FIG. 8 is a schematic diagram of a second level of a hand-pushed mower provided by a specific embodiment of the present application;

FIG. 9 is a schematic diagram of a third level of a hand-pushed mower provided by a specific embodiment of the present application;

FIG. 10 is a partial enlarged view of a supporting part provided by a specific embodiment of the present application;

FIG. 11 is a partial enlarged view of a supporting part provided by another specific embodiment of the present application;

FIG. 12 is a partial enlarged view of a supporting part provided by yet another specific embodiment of the present application;

FIG. 13 is a partial enlarged view of a supporting part provided by yet another specific embodiment of the present application;

FIG. 14 is a partial enlarged view of a supporting part provided by yet another specific embodiment of the present application;

FIG. 15 is a partial enlarged view of a supporting part provided by yet another specific embodiment of the present application;

FIG. 16 is a partial enlarged view of a supporting part provided by still another specific embodiment of the present application; and

FIG. 17 is a schematic diagram of an assembly port provided by a specific embodiment of the present application.

### DESCRIPTION OF REFERENCE NUMERALS

10—body; 20—leveling member; 201—first end; 202—second end; 21—recess; 22—via hole; 23—protrusion; 24—clamping block; 25—clamping member; 30—shifting plate; 31—main body part; 32—supporting part; 33—assembly port; 40—front wheel assembly; 50—rear wheel assembly; 51—rotating shaft; 52—rear wheel; 60—body height adjusting member; and 70—cutting member.

### DETAILED DESCRIPTION

Technical solutions of the present application will be described below clearly and completely in conjunction with the accompanying drawings. Apparently, the described embodiments are some embodiments rather than all embodiments of the present application. The present application will be described in detail below with reference to the accompanying drawings and the embodiments. It should be noted that the embodiments and features in the embodiments in the present application can be combined with each other without conflicts.

It should be noted that terms such as “first” and “second” in the description, claims and the drawings of the present application are used to distinguish similar objects, but are not necessarily used to describe a specific sequence or a precedence order.

In the present application, unless otherwise stated, orientation words such as “upper”, “lower”, “top” and “bottom” are generally used for orientations shown in the drawings, or for components that are in a vertical direction, a perpendicular direction or a gravity direction. Similarly, for convenience of understanding and description, “inside” or “outside” refers to inside or outside relative to an outline of each component itself, but the above orientation words are not used to limit the present application.

The present application solves a problem of poor standing stability of a mower in the conventional technology.

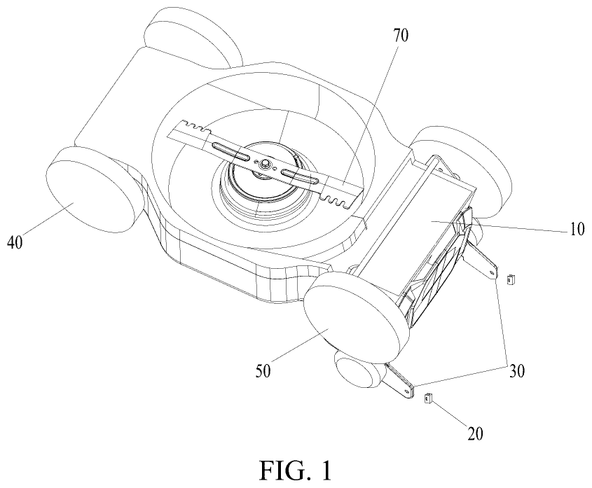

As shown in FIG. 1 to FIG. 4 and FIG. 6 to FIG. 9, a hand-pushed mower includes a body 10, a leveling member 20, a body height adjusting member 60, a shifting plate 30, a front wheel assembly 40, a rear wheel assembly 50, and a cutting member 70. The front wheel assembly 40 and the rear wheel assembly 50 are located at a front side and a rear side of the body 10 respectively. It may be understood that a rear side of the body 10 is an operation side, and the rear side of the body 10 is provided with a holding rod (not shown), such that a user may hold and operate the hand-pushed mower. The shifting plate 30 is arranged at the rear side of the body 10, and is used to keep the body 10 upright when the holding rod of the body 10 is folded and the body is in a storage state. When the body 10 is in an upright state, rear wheels 52 and the shifting plate 30 are in contact with the ground so as to provide support.

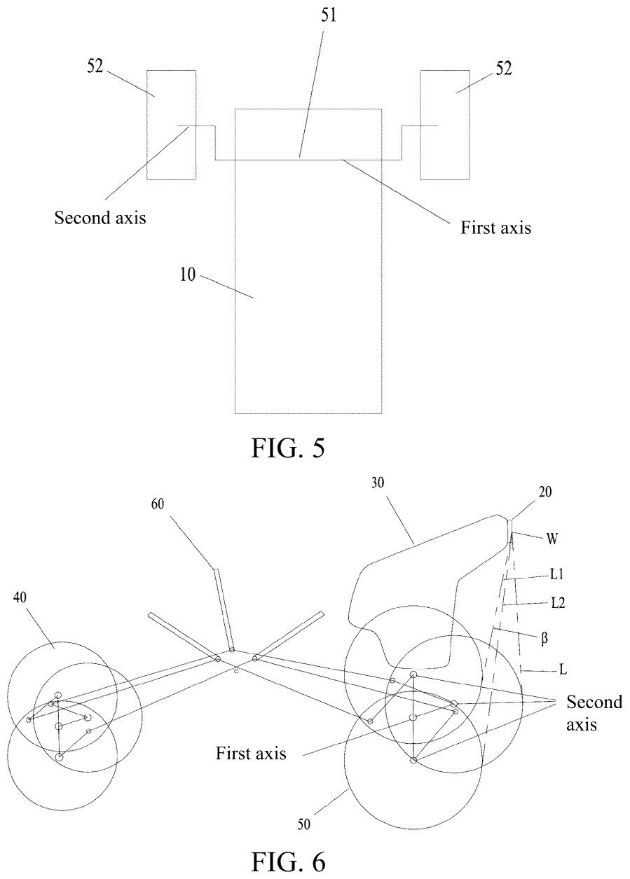

As shown in FIG. 5, the rear wheel assembly 50 includes a rotating shaft 51 and the rear wheels 52 arranged in a pair. Two ends of the rotating shaft 51 are connected to the rear wheels 52 respectively. The rotating shaft 51 is assembled at the body 10. The rotating shaft 51 is connected to the body 10 through two assembly points. A line on which a line segment between the two assembly points is located constitutes a first axis. A line on which a line segment between circle centers of the rear wheels 52 is located constitutes a second axis. The first axis and the second axis are not coaxial. In an embodiment, the rotating shaft 51 is in a similar U-shape having extension sections at two sides. A middle section of the rotating shaft 51 is assembled at the body 10, and is used as a first rotation axis. Two side sections of the rotating shaft 51 are bent inward and then bent outward separately, and then are connected to the rear wheels 52 respectively. The two side sections of the rotating shaft 51 are coaxially arranged, such that a second rotation axis is formed. In this way, the rear wheels 52 rotate around the first axis.

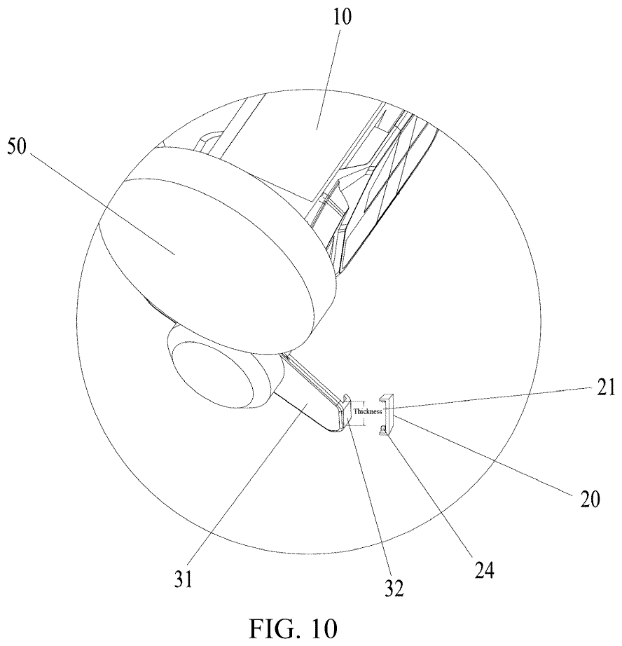

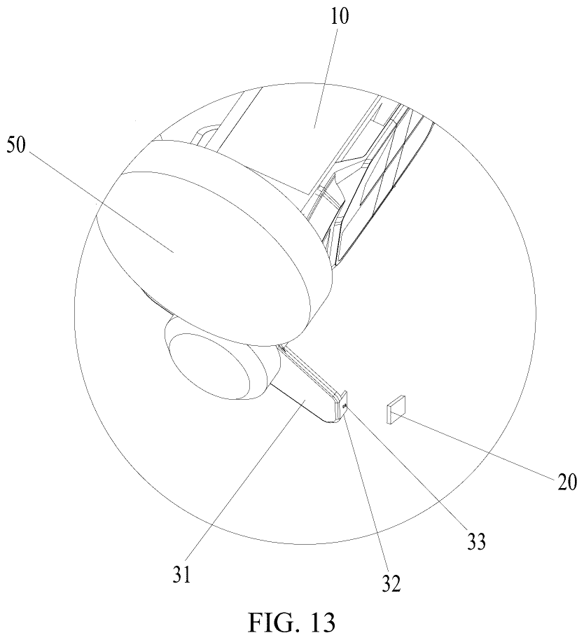

As shown in FIG. 10 to FIG. 16, the shifting plate 30 includes a main body part 31 and a supporting part 32. The main body part 31 is connected to the body 10. The leveling member 20 is arranged at the supporting part 32 and is configured to be in direct contact with the ground. In an embodiment, the main body part 31 extends backward in a direction away from the rear wheel assembly 50, and the supporting part 32 is located at an extension end of the main body part 31. Thus, the shifting plate 30 and the rear wheel assembly 50 constitute a triangular/quadrilateral structure supported by two points, and stability of the body 10 in the upright state is ensured.

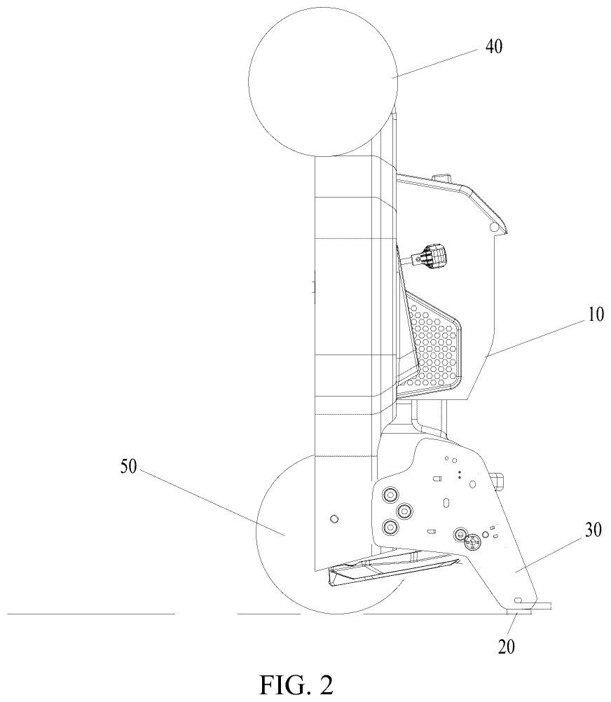

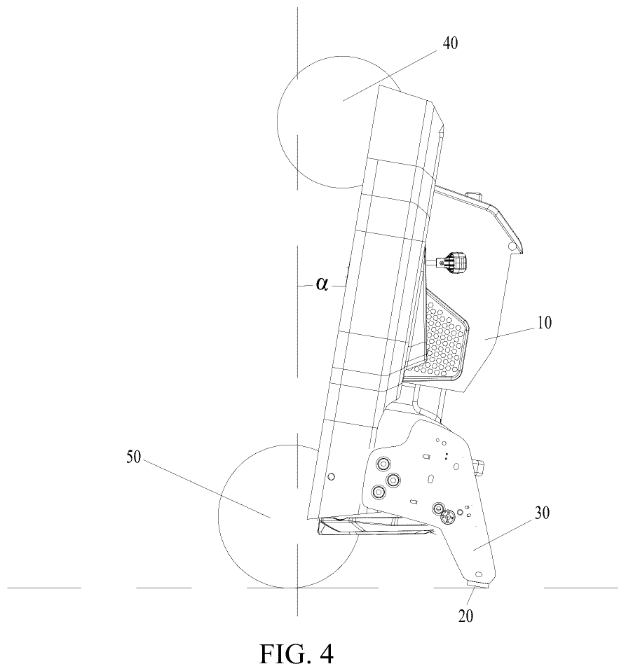

In an embodiment, as shown in FIG. 2, FIG. 4, and FIG. 5 to FIG. 9, the body height adjusting member 60 operates at two or more levels, which provides a cutting height capability adapting to different landforms and lawn conditions for the mower. At different levels, a plane of the body 10 has different heights from the ground, thus satisfying operation requirements of different cutting heights. The body height adjusting member 60 is configured to drive the rear wheels 52 to rotate around the first axis so as to adjust a height of the body 10. When the body 10 is in the upright state, the rear wheels 52 are tangent to the ground. In addition, a contact position between the leveling member 20 and the ground changes with a change between the two or more levels under an effect of the body height adjusting member 60. At least part of the leveling member 20 is in contact with the ground at one or more of the two or more levels. Specifically, as shown in FIG. 2, at a level, the leveling member 20 is in surface contact with and the ground. As shown in FIG. 4, at a level, the leveling member 20 is in line contact with and the ground. It may be understood that, the leveling member 20 has a plate-shaped or block-shaped structure, and the body 10 has different attitudes at different levels, such that included angles between the leveling member 20 and the ground are different, and further contact conditions with the ground are different.

In an embodiment, as shown in FIG. 2 and FIG. 4, in the upright state, an included angle α between the body 10 and a vertical direction ranges from 0°to 20°. That is, at different levels, an attitude range of the body 10 is from an attitude of being perpendicular to an attitude of being backward inclined by 20°.

With FIG. 2 as an example, the included angle α between the body 10 and the vertical direction is 0°. That is, in this case, the included angle between the body 10 and the ground is 90°, and one side of the shifting plate 30 closer to the ground is parallel to the ground. Thus, a bottom surface of the leveling member 20 arranged at the shifting plate 30 is in contact, that is, surface contact, with the ground. The contact method may provide maximum stability in a static state, evenly distribute a weight of the body 10, and reduce local abrasion and pressure concentration. However, when the included angle between the body 10 and the ground is not 90°, one side of the shifting plate 30 closer to the ground is not parallel to the ground. In this case, an edge of the bottom surface of the leveling member 20 arranged at the shifting plate 30 is in contact, that is, line contact, with the ground. A distance between the body 10 and the ground is increased due to a height change of the body height adjusting member 60, and the leveling member 20 may provide optimal stability in different use situations with the rear wheel assembly 50 as a fulcrum. Clearly, when the included angle between the body 10 and the ground is another angle, that is, when the body height adjusting member 60 is located at another level, the leveling member 20 is in surface contact with the ground, and the included angle is not limited to 90°, and may be selected according to actual needs.

Further, when the body 10 is in the upright state, the leveling member 20 is in surface contact with the ground at any one of the two or more levels. In an embodiment, the supporting part 32 is not of a flat plate structure, and is of a curved structure, such as an arc-shaped or polygonal structure. Accordingly, the leveling member 20 is arc-shaped or polygonal. In this way, at any one of the two or more levels, the leveling member 20 has a certain area to make contact with the ground, such that contact stability with the ground is ensured. Clearly, an angle of an arc shape or a polygon of the supporting part 32 is adjusted, and the leveling member 20 may be in line contact with the ground at any one of the two ore more levels, such that a contact area with the ground is reduced, and a problem of scuffing and abrading the ground is avoided as much as possible. The contact method may be selected according to actual needs.

In an embodiment, as shown in FIG. 6 to FIG. 9, when the body height adjusting member 60 is at a lowest level, a tangent line of a corresponding one of the rear wheels 52 located at one side of the rear wheels 52 away from the front wheel assembly 40 and passing through a preset point W of the leveling member 20 is L1, and when the body height adjusting member 60 is at a highest level, a tangent line of the corresponding rear wheel located at one side of the rear wheels 52 away from the front wheel assembly 40 and passing through the preset point W of the leveling member 20 is L2. An included angle β between the tangent line L1 and the tangent line L2 is an acute angle. Through the technical solution of the present application, axes of the rear wheels 52 and the rotating shaft 51 are not coaxial, such that the body height adjusting member 60 may drive the rear wheels 52 to rotate to adjust the height of the body. In addition, the included angle β between the tangent lines L1 and L2 of the corresponding rear wheel 52 located at the side of the rear wheels 52 away from the front wheel assembly 40 and passing through the preset point W of the leveling member 20 at the lowest level and at the highest level respectively is the acute angle, such that when the body 10 is stored vertically, the body has a sufficiently wide and stable bottom surface at each level, so as to resist slight vibration or external impact, and meanwhile, a change of an angular relationship between the rear wheels 52 and the supporting part 32 at each level is controlled to float within a small angle range. Mechanical performance of the body is improved by optimizing a supporting structure and geometrical parameters. A problem of fluctuation of a center of gravity caused by an architectural change in a mechanical movement process is better solved. Thus, reliable defense of the apparatus is ensured even if the apparatus encounters complex external factors, and overall anti-tipping performance is improved. In this way, the mower may be stored vertically in a more secure and stable manner.

It may be understood that the tangent lines L1 and L2 are located at the side of the rear wheels 52 away from the front wheel assembly 40, that is, located at one side closer to the leveling member 20 or at one side in contact with the ground in the upright state.

It should be noted that the preset point W of the leveling member 20 may be a center of gravity of the leveling member 20, or a point on a plane of the leveling member 20 close to the ground, or any point on the leveling member 20. The preset point is used as a reference point to explain a changing relationship of the included angle between the tangent lines L1 and L2, so a specific position of the preset point does not need to be limited.

In an embodiment, the included angle β is less than or equal to 15°. In the parameter range, the body 10 has as small an angular deviation as possible at each level, an excessive deviation angle of the center of gravity of the body 10 is avoided, and it is ensured that the body 10 may have high standing stability at each level.

Further, in an embodiment, as shown in FIG. 6, in the upright state, a line segment constituted by a contact point between the leveling member 20 and the ground and a contact point between the corresponding rear wheel 52 and the ground is L, and a distance between an intersection point of a vertical line on which the center of gravity of the body 10 is located and the line segment L and a midpoint of the line segment L is less than or equal to ±150 mm. Through the arrangement, the body 10 may be kept in a desirable standing state in the upright state at each level, potential shaking or overturning of the body 10 in the upright state is eliminated, and the body 10 may have relatively high standing stability in the upright state at each level. It may be understood that a plus or a minus of the distance between the intersection point of the vertical line on which the center of gravity of the body 10 is located and the line segment L and the midpoint of the line segment L indicates which side of the midpoint of the line segment L the intersection point of the vertical line on which the center of gravity of the body 10 is located and the line segment L is located at. For example, as shown in FIG. 6, when the intersection point of the vertical line on which the center of gravity of the body 10 is located and the line segment L is located at a left side of the midpoint of the line segment L, the distance is minus, and when the intersection point is located at a right side of the midpoint of the line segment L, the distance is plus. When the intersection point of the vertical line on which the center of gravity of the body 10 is located and the line segment L coincides with the midpoint of the line segment L, the distance is 0.

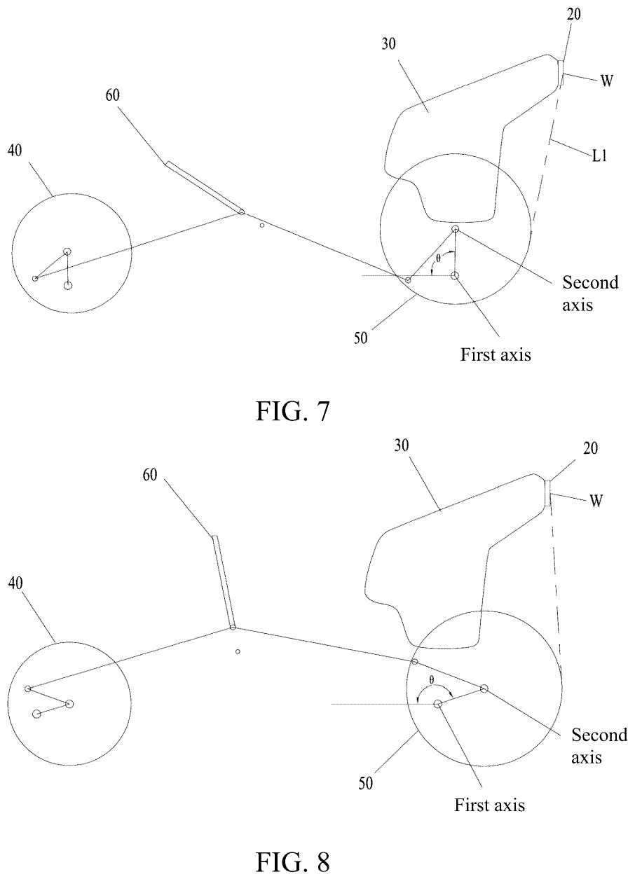

In an embodiment, as shown in FIG. 7 to FIG. 9, a rotation angle θ of each of the rear wheels 52 ranges from 90° to 270°. It may be understood that the rotation angle θ of each of the rear wheels 52 is an angle by which the rear wheel 52 rotates clockwise with a left-side horizontal line extending from the first axis to the front wheel assembly 40 as 0°. Through the arrangement, the level of the body height adjusting member 60 has a greater adjustable range, thus adapting to various application scenes and landforms.

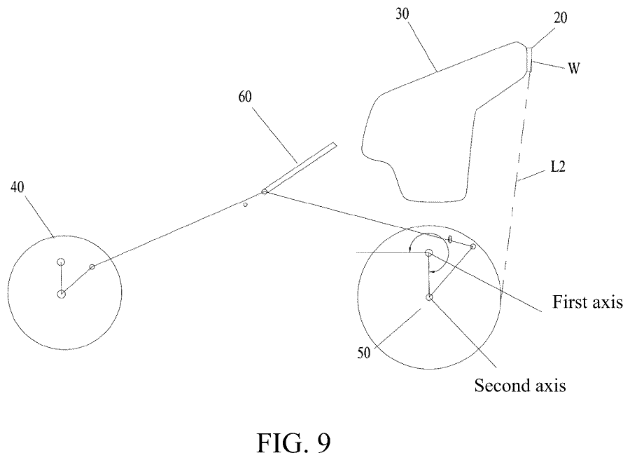

In an embodiment, a size of each of the rear wheels 52 is identical to that of a front wheel of the front wheel assembly 40, the rotation angle θ of each of the rear wheels 52 satisfies: 90°≤θ≤270°. A distance between the second axis and the first axis is greater than or equal to a vertical distance between a lowest cutting plane of the hand-pushed mower at the highest level of the body height adjusting member 60 and that of the hand-pushed mower at the lowest level of the body height adjusting member. Alternatively, a size of each of the rear wheels 52 is greater than or equal to that of a front wheel of the front wheel assembly 40, a rotation angle θ of each of the rear wheels 52 satisfies: 90°<θ<270°. A distance between the second axis and the first axis is greater than a vertical distance between a lowest cutting plane of the hand-pushed mower at the highest level of the body height adjusting member 60 and that of the hand-pushed mower at the lowest level of the body height adjusting member. The lowest cutting plane is a cutting plane of the cutting member 70 during cutting at the lowest level. It may be understood that, the size of each of the rear wheels 52 is identical to that of the front wheel of the front wheel assembly 40, and the distance between the second axis and the first axis is greater than or equal to the vertical distance between the lowest cutting plane of the hand-pushed mower at the highest level of the body height adjusting member 60 and that of the hand-pushed mower at the lowest level of the body height adjusting member, and the rotation angle θ of each of the rear wheels 52 is 90°. In this case, the lowest cutting plane is located at a lowest level relative to the ground, and the level is also a lowest level of the body height adjusting member 60, as shown in FIG. 7. When the rotation angle θ of each of the rear wheels 52 is 270°, the lowest cutting plane is located at a highest level relative to the ground, and the level is also a highest level of the body height adjusting member 60, as shown in FIG. 9.

The size of each of the rear wheels 52 is greater than that of the front wheel of the front wheel assembly 40, or the size of each of the rear wheels 52 is equal to that of the front wheel of the front wheel assembly 40, the distance between the second axis and the first axis is greater than the vertical distance between the lowest cutting plane of the hand-pushed mower at the highest level of the body height adjusting member 60 and that of the hand-pushed mower at the lowest level of the body height adjusting member, and the rotation angle θ of each of the rear wheels 52 is close to 90°. In this case, the lowest cutting plane is located at the lowest level relative to the ground, and the level is also the lowest level of the body height adjusting member 60. When the rotation angle θ of each of the rear wheels 52 is close to 270°, the lowest cutting plane is located at the highest level relative to the ground, and the level is also the highest level of the body height adjusting member 60.

Through the arrangement, it is ensured that when the shifting plate 30 and the rear wheels 52 support the body 10 to stand upright, and the change of the angular relationship between the rear wheels 52 and the supporting part 32 at each level is controlled to float within the small angle range, a backward deviation angle of the center of gravity is smaller, and an angle between the shifting plate 30 and the ground is smaller when the body 10 is laid flat. Thus, the body 10 is more compact, a product packaging height is shortened, and production cost is reduced. Further, in an embodiment, a radius size of each of the rear wheels 52 is 20 mm greater than the distance between the second axis and the first axis. In other words, a distance between the first axis and an outer periphery of the rear wheel 52 is 20 mm.

In an embodiment, hardness of the leveling member 20 is less than that of the supporting part 32. That is, the leveling member 20 is made of a flexible material. The leveling member 20 is arranged, and the leveling member 20 is selected to be made of the flexible material. The leveling member 20 may adapt to different landforms and provide optimal support for the body 10, and standing stability of the body 10 at any level is ensured through coordination of a position of the rear wheel assembly 50. Meanwhile, ground abrasion caused by friction may be effectively reduced. An additional damping effect is further provided to disperse pressure of the supporting part 32. Stability of the body 10 is further enhanced, and potential shaking or overturning of the body 10 in a storage state is eliminated. In addition, the leveling member 20 may better adapt to a tiny irregular surface, such that an attaching effect of the uneven ground and the device when the entire device is mounted is improved, and imbalance of the shifting plate 30 and the rear wheels 52 making contact with the ground is reduced. In addition, the leveling member 20 may absorb some forces in a case that a side force or uneven external disturbance is applied. Thus, imbalance between the shifting plate 30 and the rear wheels 52 making contact with the ground is reduced, and the problem of scuffing and abrading the ground by the shifting plate 30 during shaking is avoided.

In an embodiment, the shifting plate 30 is made of a hard material. Further, the shifting plate 30 is made of a metal material. For example, the shifting plate 30 is an iron plate, an alloy plate, a stainless steel plate, etc.

In an embodiment, the leveling member 20 is made of a flexible material. Further, due to friction between the leveling member 20 and the ground, the leveling member 20 has wear resistance in addition to flexibility, thus ensuring the service life. In an embodiment, the flexible material includes at least one of plastic, silica gel, rubber, teflon, foamed polyurethane, a polyurethane elastomer, or flexible polyurethane.

In an embodiment, one or two shifting plates 30 are provided. The shifting plate is located at one end of a rear side of the body 10 or the two shifting plates 30 are located at two ends of a rear side of the body 10 respectively, such that the body 10 may be stably kept upright in the upright state. Accordingly, two leveling members 20 are alternatively provided.

In an embodiment, to ensure that the leveling member 20 is in full and firm contact with the ground, the leveling member 20 is of a solid structure. Clearly, the leveling member 20 or may be of a hollow structure. That is, the leveling member 20 is provided with a hollow cavity, and the hollow cavity is filled with air. Through the arrangement, the hollow cavity may play a further buffering role, such that the leveling member 20 may make contact with the ground more flexibly, and manufacturing cost of the leveling member 20 may be saved. Further, multiple supporting columns are alternatively arranged at intervals in the hollow cavity. In this way, the supporting columns may more fully transfer gravity of the body 10 to the ground while playing a buffering role in the hollow cavity, such that the body 10 is ensured to be in full contact with the ground, and the body 10 is firmly kept in the upright state.

In an embodiment, the supporting part 32 and the main body part 31 are integrally formed. Through the arrangement, the shifting plate 30 may be ensured to have sufficient structural strength, thus prolonging the service life.

In an optional embodiment, the supporting part 32 is detachably connected to the main body part 31. Through the arrangement, when the shifting plate 30 needs to be maintained and replaced, only the corresponding supporting part 32 or main body part 31 needs to be replaced, and the entire shifting plate 30 does not need to be replaced, such that operation of the maintenance personnel is facilitated, and maintenance cost is reduced.

In an optional embodiment, the supporting part 32 is rotatably connected to the main body part 31, and the leveling member 20 is located at one side of the supporting part 32 away from the main body part 31. In an embodiment, one end of the main body part 31 and one end of the supporting part 32 close to each other each is provided with a rotation hole, and the rotating shaft penetrates upper rotation holes of the two parts separately, such that the supporting part 32 may rotate relative to the main body part 31. With the supporting part 32 in a rotatable manner, the leveling member 20 on the supporting part 32 may always be oriented toward the ground along with gravity and is kept in surface contact with the ground, such that the contact area between the leveling member 20 and the ground is increased, and contact stability with the ground is improved.

In an embodiment, the main body part 31 or the supporting part 32 is provided with a positioning member, the leveling member 20 is provided with a matching member, and the matching member is connected to the positioning member in a clamping manner, such that the leveling member 20 is arranged around the supporting part 32. In an embodiment, the positioning member may be a protruding member while the matching member is a recessed member, or the positioning member is a recessed member while the matching member is a protruding member. Thus, the leveling member 20 and the supporting part 32 are clamped and fixed through protrusion-recess fitting. Clamping connection between the leveling member 20 and the supporting part 32 facilitates mounting and dismounting, and further high connection stability can be kept during use.

In an embodiment, the shifting plate 30 is not provided with the leveling member 20, and a contact part between the supporting part 32 and the ground is a supporting surface. In a case that the shifting plate 30 is provided with the leveling member 20, an area of the leveling member 20 may be greater than, less than or equal to that of and the supporting surface. In an embodiment, the area of the leveling member 20 is less than that of the supporting surface, and the leveling member 20 is located at a middle position of the supporting part 32, such that contact stability is ensured. Clearly, the leveling member 20 may alternatively be matched with the supporting surface, that is, the area of the leveling member is equal to that of the supporting surface, such that the leveling member is in contact with the ground more fully. Further, the area of the leveling member 20 may be greater than that of the supporting surface, that is, an edge of the leveling member 20 extends beyond an edge of the supporting surface, such that contact stability with the ground may be further improved. The method may be selected according to actual needs.

In an optional embodiment, the hand-pushed mower may not include the leveling member 20. In an embodiment, the hand-pushed mower includes a body 10, a body height adjusting member 60, a shifting plate 30, a front wheel assembly 40, a rear wheel assembly 50, and a cutting member 70. The rear wheel assembly 50 includes a rotating shaft 51 and rear wheels 52 arranged in a pair. Two ends of the rotating shaft 51 are connected to the rear wheels 52 respectively. The rotating shaft 51 is assembled at the body 10. The rotating shaft 51 is connected to the body 10 through two assembly points. A line on which a line segment between the two assembly points is located constitutes a first axis. A line on which a line segment between circle centers of the rear wheels 52 is located constitutes a second axis. The first axis and the second axis are not coaxial. The body height adjusting member 60 operates at two or more levels. The body height adjusting member 60 is configured to drive the rear wheels 52 to rotate around the first axis so as to adjust a height of the body 10. The shifting plate 30 is configured to keep the body 10 upright when a holding rod of the body 10 is folded and the body 10 is in a storage state. The shifting plate 30 includes a main body part 31 and a supporting part 32. The main body part 31 is connected to the body 10. The supporting part 32 is configured to be in direct contact with ground. When the body 10 is in an upright state, the rear wheels 52 are tangent to the ground. When the body height adjusting member 60 is at a lowest level, a tangent line of a corresponding one of the rear wheel 52 located at one side of the rear wheels 52 away from the front wheel assembly 40 and passing through a preset point W of the supporting part 32 is L1. When the body height adjusting member 60 is at a highest level, a tangent line of the corresponding rear wheel 52 located at one side of the rear wheels 52 away from the front wheel assembly 40 and passing through the preset point W of the supporting part 32 is L2. An included angle β between the tangent line L1 and the tangent line L2 is an acute angle.

Further, in a case that no leveling member 20 is included, a line segment constituted by a contact point between the supporting part 32 and the ground and a contact point between the corresponding rear wheel 52 and the ground is L, and a distance between an intersection point of a vertical line on which a center of gravity of the body 10 is located and the line segment L and a midpoint of the line segment L is less than or equal to ±150 mm.

Specific structures of the shifting plate 30 and the leveling member 20 will be described below.

### Embodiment 1

In the embodiment 1, a supporting part 32 and a main body part 31 are arranged with an included angle formed therebetween. That is, the supporting part 32 and the main body part 31 are arranged in an L-shaped bending manner. In this way, one side, closer to the ground, of the leveling member 20 arranged at the supporting part 32 is provided with a large surface, a large contact area is achieved, and contact stability with the ground is improved.

In an embodiment, the included angle between the supporting part 32 and the main body part 31 is 90°. The main body part 31 is arranged vertically, and the supporting part 32 is in an inward bent state. Through the arrangement, a contact area between the leveling member 20 arranged at the supporting part 32 and the ground may be as large as possible, and inward bending may save space and prevent the supporting part 32 from exceeding a width of a body 10. Clearly, another angle may be alternatively formed between the supporting part 32 and the main body part 31, and the supporting part 32 may be bent outward, which may be selected according to actual needs.

As shown in FIG. 10, each of two ends of the leveling member 20 is provided with a snap-fitting structure, and the snap-fitting structure is fixed to an edge of the supporting part 32 in a clamping manner. In an embodiment, the leveling member 20 is provided with a recess 21. In FIG. 10, inner walls at upper and lower sides of the recess 21 are provided with clamping blocks 24. The clamping blocks 24 are spaced apart from a recess bottom of the recess 21. The supporting part 32 is accommodated in a space between the clamping blocks 24 and the recess bottom in the recess 21, and is limited by clamping upper and lower edges of the supporting part 32 by the clamping blocks 24. Further, one end of the supporting part 32 away from the main body part 31 is provided with a limiting section, and the limiting section is bent in an L shape, such that the leveling member 20 is limited and stopped, and the leveling member 20 is prevented from being separated from one end of the supporting part 32.

In an optional embodiment, similar to the arrangement in FIG. 10, the leveling member 20 is provided with the recess 21, and the recess 21 extends in a horizontal direction in FIG. 10. A minimum distance between any one group of opposite faces in the leveling member 20 is less than a thickness of the supporting part 32, such that the leveling member 20 is arranged around the supporting part 32. It should be noted that in FIG. 10, the thickness of the supporting part 32 is a size in a vertical direction. In an embodiment, the leveling member 20 is arranged in a U-shaped structure having two sides bent inward, so as to be arranged around the supporting part 32 and tightly clamp the supporting part 32 without other fixing structures, which is simple and convenient. Further, an inner wall of the recess 21 may be alternatively provided with a clamping member for arranging the leveling member 20 around the supporting part 32. With the clamping member, connection firmness between the leveling member 20 and the supporting part 32 may be further improved.

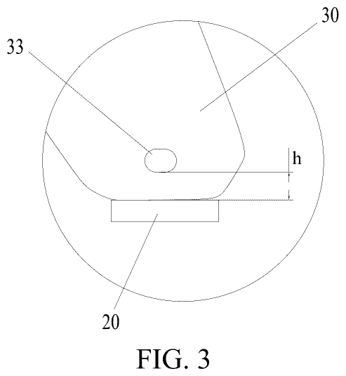

Further, as shown in FIG. 3 and FIG. 11 to FIG. 16, to ensure that the leveling member 20 is firmly connected to a shifting plate 30, the main body part 31 or the supporting part 32 is provided with an assembly port 33, and the assembly port 33 is a closed port.

Further, the shifting plate 30 further includes a fastener. The leveling member 20 is fixed to the supporting part 32 through the assembly port 33 and the fastener. With connecting assembly of the fastener and the assembly port, the leveling member 20 may be firmly fixed to the supporting part 32. Thus, the leveling member 20 is prevented from falling off as much as possible, and unnecessary maintenance and replacement are reduced.

In an embodiment, the fastener includes a screw. The leveling member 20 is provided with an assembly hole corresponding to the assembly port 33, and the screw is configured to penetrate the assembly port 33 and extend into the assembly hole to be fixed to the leveling member 20. In an embodiment, the assembly hole may be a threaded hole, such that the screw is connected to the leveling member 20 in a threaded manner. Clearly, the fastener may alternatively be of another type of structure such as a rivet, and may be selected according to actual needs.

In an optional embodiment, as shown in FIG. 17, the assembly port 33 is an opened port. It may be understood that the closed port is a port that is not in communication with an edge of a component in which the assembly port 33 is located and that is closed, and the opened port is a port in communication with an edge of a component in which the assembly port 33 is located.

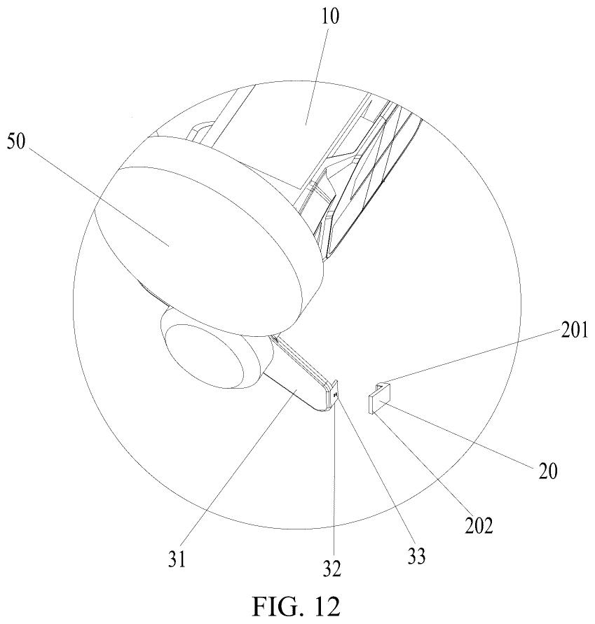

In an embodiment, as shown in FIG. 12, the assembly port 33 is located at the supporting part 32, a minimum distance h between a periphery of the assembly port 33 and an outer periphery of the supporting part 32 is greater than 2 mm. Through the arrangement, the assembly port 33 does not influence structural strength of the supporting part 32, thus ensuring the service life of the supporting part 32.

In an optional embodiment, as shown in FIG. 12, a first end 201 of the leveling member 20 is arranged around the supporting part 32, a second end 202 of the leveling member 20 extends from the supporting part 32 to the main body part 31, and the second end 202 of the leveling member 20 is fixed to the shifting plate 30 through the assembly port 33 and the fastener. In an embodiment, first ends of the leveling member 20 and the supporting part 32 each is one end away from the main body part 31, and the assembly port 33 is provided at the supporting part 32 and is located at a position close to a second end of the supporting part 32. The leveling member 20 is L-shaped. The first end 201 of the leveling member 20 is provided with a sleeving port matched with the supporting part 32, such that an extension end of the supporting part 32 penetrates the first end 201 of the leveling member 20. The second end 202 of the leveling member 20 is flush with bent surfaces of the main body part 31 and the supporting part 32 or exceeds part of the bent surfaces of the main body part 31 and the supporting part 32. Then, the fastener penetrates the assembly port 33 to be fixed to the leveling member 20.

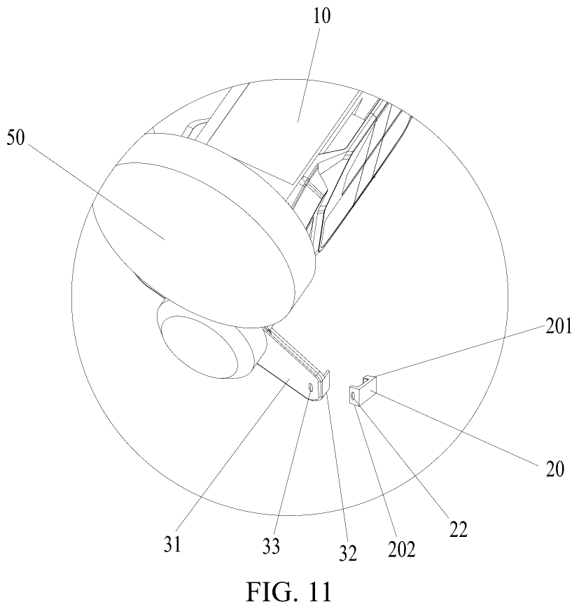

In an optional embodiment, as shown in FIG. 11, the assembly port 33 is provided at the main body part 31. The leveling member 20 is U-shaped. The first end 201 of the leveling member 20 is provided with a sleeving port matched with the supporting part 32, such that an extension end of the supporting part 32 penetrates the first end of the leveling member 20. The second end 202 of the leveling member 20 is attached to the main body part 31. Then, the fastener penetrates the assembly port 33 to be fixed to the leveling member 20. In an embodiment, the second end 202 of the leveling member 20 is further provided with a via hole 22, such that the fastener sequentially penetrates the assembly port 33 and the via hole 22, so as to fix the leveling member 20 to the main body part 31.

In an optional embodiment, different from the structure shown in FIG. 11, the first end of the supporting part 32 is provided with a limiting section. The limiting section is bent in an L shape. The first end of the supporting part 32 is also provided with an assembly port 33. The first end of the leveling member 20 is further provided with a via hole 22. Two fasteners are provided. For each of the two fasteners, the fastener penetrates the via hole 22 and the assembly port 33, such that the leveling member 20 is fixed to the supporting part 32.

It should be noted that multiple assembly ports 33 and multiple via holes 22 may alternatively be provided at an identical position, such that connection firmness is improved.

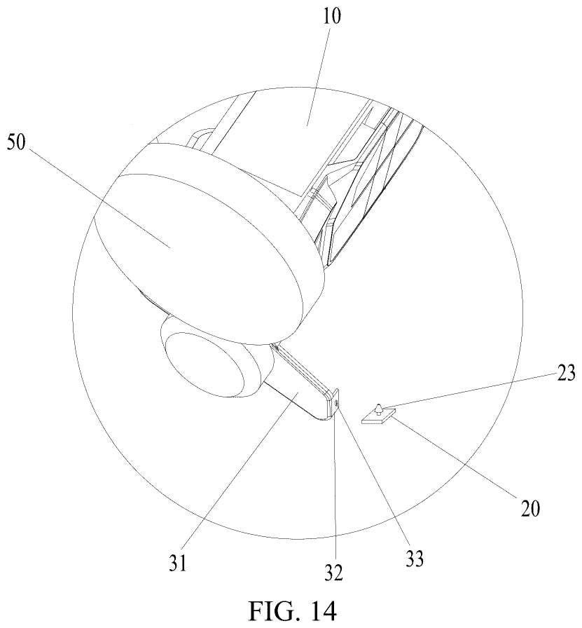

In an optional embodiment, as shown in FIG. 14, the leveling member 20 is provided with a protrusion 23, an end of the protrusion 23 is a clamping end, and the protrusion 23 is configured to penetrate the assembly port 33 and is connected to the supporting part 32 in a clamping manner. In an embodiment, the assembly port 33 is provided at the supporting part 32. The protrusion is located at one side of the leveling member 20 closer to the supporting part 32, and is arranged corresponding to the assembly port 33. The clamping end of the protrusion 23 penetrates the assembly port 33 and then is clamped and stopped by the supporting part 32. Further, one or more protrusions 23 may be provided. In a case that one protrusion 23 is provided, the protrusion 23 is located at a middle position of the leveling member 20. In a case that multiple protrusions 23 are provided, multiple assembly ports 33 are provided. The multiple protrusions 23 are arranged at an equal interval on the leveling member 20, such that connection firmness is improved.

In an optional embodiment, the supporting part 32 is provided with an accommodating recess and the assembly port 33, the assembly port 33 is in communication with the accommodating recess, an opening of the accommodating recess is located away from the body 10, the leveling member 20 is accommodated in the accommodating recess, and the fastener is configured to penetrate the assembly port 33 to be fixed to the leveling member 20. In an embodiment, the supporting part 32 is of a U-shaped structure, such that the accommodating recess is formed. The leveling member 20 is matched with the accommodating recess in size, so as to be exactly accommodated in the accommodating recess, and then is fixed to the supporting part 32 through the fastener. Clearly, the supporting part 32 may alternatively be provided with the assembly port 33, and the leveling member 20 may be provided with the accommodating recess. The supporting part 32 is provided with a clamping projection matched with the accommodating recess. The clamping projection is accommodated in the accommodating recess in a matched manner. Then, the supporting part 32 is fixed to the leveling member 20 through the fastener.

In an optional embodiment, two ends of the leveling member 20 are provided with a first locking part and a second locking part respectively, and at least one of the first locking part and the second locking part is locked to the assembly port 33. In an embodiment, the main body part 31 is provided with the assembly port 33, and the first locking part located at the second end of the leveling member 20 is locked to the assembly port 33 on the main body part 31. Further, the first end of the supporting part 32 may alternatively be provided with the assembly port 33, such that the first locking part is locked to the assembly port 33 on the supporting part 32, further improving connection firmness between the leveling member 20 and the supporting part 32.

Further, the leveling member 20 may alternatively be connected to the supporting part 32 through bonding, in addition to a connection method using the assembly port 33 and the fastener. In this way, the leveling member 20 may be directly fixed to the supporting part 32 without other structural parts, which is convenient and fast.

In an embodiment, for adapting to different connection methods, the supporting part 32 may be of at least one single shape or a combined shape of an I-shape, a J-shape, an L-shape, a T-shape, a shape of two parallel horizontal bars with a vertical bar across the two parallel horizontal bars, a C-shape, or a U-shape, which may be selected according to actual needs.

In an embodiment, one side of the leveling member 20 closer to the ground is of a flat surface, an arc-shaped surface, a trapezoidal surface, or a sharp-pointed structure.

### Embodiment 2

In the embodiment 2, a difference from Embodiment 1 is that the main body part 31 and the supporting part 32 have different structural forms.

In an embodiment, the supporting part 32 and the main body part 31 are arranged at an identical plane or at parallel planes. That is, the supporting part 32 and the main body part 31 are both arranged vertically. Through the arrangement, a contact area between the shifting plate 30 and the ground may be reduced. Thus, a contact area between a leveling member 20 and the ground is relatively small, such that ground abrasion is reduced as much as possible.

In an embodiment, as shown in FIG. 3, an assembly port 33 is a closed port, and a minimum distance h between one side of the assembly port 33 closer to the ground in an upright state and an outermost edge, close to the ground, of the supporting part 32 is greater than 2 mm. In an embodiment, an edge of the supporting part 32 is not of a shape of a regular straight line, and is of a shape of a curve or an arc having continuous bent sections. Thus, a distance between the assembly port 33 and the outermost edge of the supporting part 32 is varied at different positions. Through the arrangement, the assembly port 33 does not influence structural strength of the supporting part 32, thus ensuring the service life of the supporting part 32.

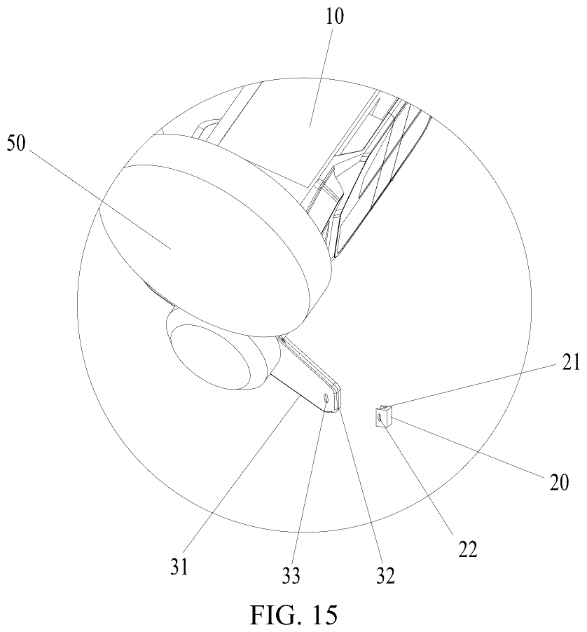

As shown in FIG. 15, the leveling member 20 is provided with a recess 21, and the recess 21 extends in a vertical direction in FIG. 15. A minimum distance between any one group of opposite faces in the leveling member 20 is less than a thickness of the supporting part 32, such that the leveling member 20 is arranged around the supporting part 32. In FIG. 15, the thickness of the supporting part 32 is a size in a horizontal direction. In an embodiment, the leveling member 20 is arranged in a U-shaped structure having two sides bent inward, so as to be arranged around the supporting part 32 and tightly clamp the supporting part 32 without other fixing structures, which is simple and convenient.

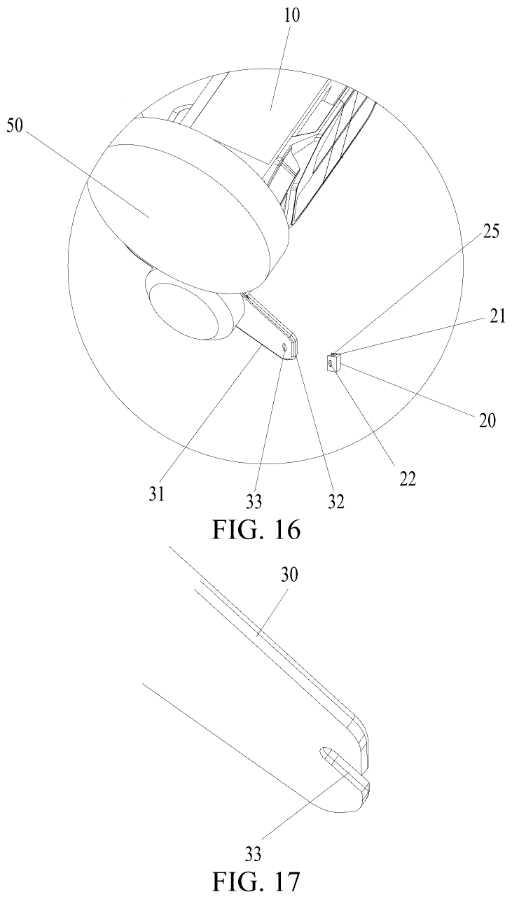

Further, as shown in FIG. 16, a clamping member 25 may be alternatively provided at an inner wall of the recess 21, such that the leveling member 20 is arranged around the supporting part 32. With the clamping member 25, connection firmness between the leveling member 20 and the supporting part 32 may be further improved.

In an optional embodiment, as shown in FIG. 15, the leveling member 20 is provided with the recess 21, such that the leveling member 20 is arranged around the supporting part 32. Each of two ends of the leveling member 20 is provided with a via hole 22 corresponding to the assembly port 33. A fastener is configured to penetrate the two via holes 22 and the assembly port 33, such that the leveling member 20 is fixed to the supporting part 32.

In an optional embodiment, a first end of the leveling member 20 is arranged around the supporting part 32, a second end of the leveling member 20 extends from the supporting part 32 to the main body part 31, and one or two ends of the leveling member 20 are fixed to the main body part 31 through the assembly port 33 and the fastener. In an embodiment, first ends of the leveling member 20 and the supporting part 32 each is one end away from the main body part 31, and the assembly port 33 is provided at the supporting part 32 or the main body part 31, which is determined according to a length of the leveling member 20. The leveling member 20 is L-shaped. The first end of the leveling member 20 is provided with a sleeving port matched with the supporting part 32, such that an extension end of the supporting part 32 penetrates the first end of the leveling member 20. Then, the fastener penetrates the assembly port 33, such that the second end of the leveling member 20 is fixed to the supporting part 32 or the main body part 31.

In an optional embodiment, the leveling member 20 is provided with a protrusion, an end of the protrusion is a clamping end, and the protrusion is configured to penetrate the assembly port 33 and is connected to the supporting part 32 in a clamping manner. In an embodiment, the assembly port 33 is provided at the supporting part 32 or the main body part 31. The protrusion is located at one side of the leveling member 20 closer to the shifting plate 30, and is arranged corresponding to the assembly port 33. The clamping end of the protrusion penetrates the assembly port 33 and then is clamped and stopped by the shifting plate 30. Further, one or more protrusions may be provided. In a case that one protrusion is provided, the protrusion is located at a middle position of the leveling member 20. In a case that multiple protrusions are provided, multiple assembly ports 33 are provided. The multiple protrusions are arranged at an equal interval on the leveling member 20, such that connection firmness is improved.

In an optional embodiment, the leveling member 20 is provided with an accommodating recess and a via hole 22, the via hole 22 is in communication with the accommodating recess, an end of the supporting part 32 is adaptively accommodated in the accommodating recess, the supporting part 32 is provided with an assembly port 33, the shifting plate 30 further includes a fastener, and the fastener is configured to penetrate the via hole 22 and the assembly port 33 to be fixed to the supporting part 32. In an embodiment, the leveling member 20 is of a U-shaped structure, such that the accommodating recess is formed. An end of the supporting part 32 is matched with the accommodating recess in size, so as to be exactly accommodated in the accommodating recess, and then is fixed to the leveling member 20 through the fastener. Clearly, an end of the supporting part 32 may alternatively be of a U-shaped structure, such that the accommodating recess is formed. An opening of the accommodating recess is located away from the body 10. The leveling member 20 is accommodated in the accommodating recess, and the fastener penetrates the assembly port 33 to be fixed to the leveling member 20.

From the above description, it may be seen that the embodiments of the present application achieve the following technical effects: The hand-pushed mower includes the body 10, the leveling member 20, the body height adjusting member 60, the shifting plate 30, the front wheel assembly 40, the rear wheel assembly 50, and the cutting member 70. The rear wheel assembly 50 includes the rotating shaft 51 and the rear wheels 52 arranged in a pair. The two ends of the rotating shaft 51 are connected to the rear wheels 52 respectively. The rotating shaft 51 is assembled at the body 10. The rotating shaft 51 is connected to the body 10 through the two assembly points. The line on which the line segment between the two assembly points is located constitutes the first axis. The line on which the line segment between the circle centers of the rear wheels 52 is located constitutes the second axis. The first axis and the second axis are not coaxial. The body height adjusting member 60 operates at two or more levels. The body height adjusting member 60 is configured to drive the rear wheels 52 to rotate around the first axis so as to adjust the height of the body 10. The shifting plate 30 is configured to keep the body 10 upright when the holding rod of the body 10 is folded and the body 10 is in the storage state. The shifting plate 30 includes the main body part 31 and the supporting part 32. The main body part 31 is connected to the body 10. The leveling member 20 is arranged at the supporting part 32 and is configured to be in direct contact with the ground. When the 10 body is in the upright state, the rear wheel assembly 50 is tangent to the ground. At each level of the body height adjusting member 60, the included angle β between all the line segments L constituted by the contact point between the leveling member 20 and the ground and the contact points between the rear wheels 52 and the ground is the acute angle. The axes of the rear wheels 52 and the rotating shaft 51 are not coaxial, such that the body height adjusting member 60 may drive the rear wheels 52 to rotate to adjust the height of the body. In addition, at each level, the included angle β between all the line segments L constituted by the contact point between the leveling member 20 and the ground and the contact points between the rear wheels 52 and the ground is the acute angle, such that when the body 10 is stored vertically, the body has a sufficiently wide and stable surface, so as to resist slight vibration or external impact, and meanwhile, the change of the angular relationship between the rear wheels 52 and the supporting part 32 at each level is controlled to float within the small angle range. The mechanical performance of the body is improved by optimizing the supporting structure and the geometrical parameters. The problem of fluctuation of the center of gravity caused by the architectural change in the mechanical movement process is better solved. Thus, the reliable defense of the apparatus is ensured even if the apparatus encounters the complex external factors, and the overall anti-tipping performance is improved. In this way, the mower may be stored vertically in a more secure and stable manner. In addition, the leveling member 20 is arranged at the supporting part 32, the leveling member 20 may adapt to different landforms and provide optimal support for the body 10, and standing stability of the body 10 at any level is ensured through coordination of the position of the rear wheel assembly 50. Meanwhile, the ground abrasion caused by the friction may be effectively reduced. The additional damping effect is further provided to disperse the pressure of the supporting part 32. The stability of the body 10 is further enhanced, and the potential shaking or overturning of the body 10 in the storage state is eliminated.

Obviously, the embodiments described above are merely some embodiments rather than all embodiments of the present application. Based on the embodiments of the present application, variations or modifications in different forms made by those of ordinary skill in the art without creative efforts should fall within the protection scope of the present application

What is claimed is:

1. A hand-pushed mower, comprising:
a body;
a leveling member;
a body height adjusting member;
a shifting plate;
a front wheel assembly;
a rear wheel assembly; and
a cutting member;
wherein the rear wheel assembly comprises a rotating shaft and rear wheels arranged in a pair, two ends of the rotating shaft are connected to the rear wheels respectively, the rotating shaft is assembled at the body, the rotating shaft is connected to the body through two assembly points, a line on which a line segment between the two assembly points is located constitutes a first axis, a line on which a line segment between circle centers of the rear wheels is located constitutes a second axis, and the first axis and the second axis are not coaxial;
the body height adjusting member operates at two or more levels, the body height adjusting member is configured to drive the rear wheels to rotate around the first axis so as to adjust a height of the body, the shifting plate is configured to keep the body upright when a holding rod of the body is folded and the body is in a storage state, the shifting plate comprises a main body part and a supporting part, the main body part is connected to the body, and the leveling member is arranged at the supporting part and is configured to be in direct contact with ground; and
when the body is in an upright state, the rear wheels are tangent to the ground, when the body height adjusting member is at a lowest level, a tangent line of a corresponding one of the rear wheels located at one side of the rear wheels away from the front wheel assembly and passing through a preset point W of the leveling member is L1, when the body height adjusting member is at a highest level, a tangent line of the corresponding rear wheel located at one side of the rear wheels away from the front wheel assembly and passing through the preset point W of the leveling member is L2, and an included angle β between the tangent line L1 and the tangent line L2 is an acute angle.

2. The hand-pushed mower according to claim 1, wherein at least part of the leveling member is in contact with the ground at one or more of the two or more levels, and hardness of the leveling member is less than that of the supporting part.

3. The hand-pushed mower according to claim 1, wherein in the upright state, a line segment constituted by a contact point between the leveling member and the ground and a contact point between the corresponding rear wheel and the ground is L, and a distance between an intersection point of a vertical line on which a center of gravity of the body is located and the line segment L and a midpoint of the line segment L is less than or equal to ±150 mm.

4. The hand-pushed mower according to claim 1, wherein the included angle β is less than or equal to 15°.

5. The hand-pushed mower according to claim 1, wherein
a size of each of the rear wheels is identical to that of a front wheel of the front wheel assembly, and a rotation angle θ of each of the rear wheels satisfies: 90°≤θ≤270°, wherein a distance between the second axis and the first axis is greater than or equal to a vertical distance between a lowest cutting plane of the hand-pushed mower at the highest level of the body height adjusting member and that of the hand-pushed mower at the lowest level of the body height adjusting member; or,
a size of each of the rear wheels is greater than or equal to that of a front wheel of the front wheel assembly, and a rotation angle θ of each of the rear wheels satisfies: 90°<θ<270°, wherein a distance between the second axis and the first axis is greater than a vertical distance between a lowest cutting plane of the hand-pushed mower at the highest level of the body height adjusting member and that of the hand-pushed mower at the lowest level of the body height adjusting member, wherein
the lowest cutting plane is a cutting plane of the cutting member during cutting at the lowest level.

6. The hand-pushed mower according to claim 1, wherein a radius size of each of the rear wheels is 20 mm greater than a distance between the second axis and the first axis.

7. The hand-pushed mower according to claim 1, wherein the supporting part and the main body part are arranged with an included angle formed therebetween.

8. The hand-pushed mower according to claim 1, wherein the supporting part and the main body part are arranged at an identical plane or at parallel planes.

9. The hand-pushed mower according to claim 8, wherein the main body part or the supporting part is provided with an assembly port, and the assembly port is a closed port or an opened port.

10. The hand-pushed mower according to claim 9, wherein the assembly port is located at the main body part, or the assembly port is located at the supporting part and the supporting part and the main body part are arranged at an identical plane or at parallel planes, the assembly port is the closed port, and a minimum distance h between one side of the assembly port closer to the ground in the upright state and an outermost edge, close to the ground, of the supporting part is greater than 2 mm.

11. The hand-pushed mower according to claim 9, wherein the supporting part and the main body part are arranged with an included angle formed therebetween, the assembly port is located at the supporting part, the assembly port is the closed port, and a minimum distance h between a periphery of the assembly port and an outer periphery of the supporting part is greater than 2 mm.

12. The hand-pushed mower according to claim 9, wherein the shifting plate further comprises a fastener, and the leveling member is fixed to the supporting part through the assembly port and the fastener.

13. The hand-pushed mower according to claim 8, wherein the main body part or the supporting part is provided with a positioning member, the leveling member is provided with a matching member, and the matching member is connected to the positioning member in a clamping manner, such that the leveling member is arranged around the supporting part.

14. The hand-pushed mower according to claim 8, wherein the leveling member is provided with a recess; and
a minimum distance between any one group of opposite faces in the leveling member is less than a thickness of the supporting part, such that the leveling member is arranged around the supporting part; or,
a clamping member is arranged at an inner wall of the recess, and a minimum distance between any one group of opposite faces of the leveling member is less than a thickness of the supporting part, such that the leveling member is arranged around the supporting part.

15. The hand-pushed mower according to claim 9, wherein a first end of the leveling member is arranged around the supporting part, a second end of the leveling member extends from the supporting part to the main body part, the shifting plate further comprises a fastener, and one or two ends of the leveling member are fixed to the shifting plate through the assembly port and the fastener.

16. The hand-pushed mower according to claim 15, wherein the fastener comprises a screw, the leveling member is provided with an assembly hole corresponding to the assembly port, and the screw is configured to penetrate the assembly port and extend into the assembly hole to be fixed to the leveling member.

17. The hand-pushed mower according to claim 9, wherein the leveling member is provided with a protrusion, an end of the protrusion is a clamping end, and the protrusion is configured to penetrate the assembly port and is connected to the supporting part in a clamping manner.

18. The hand-pushed mower according to claim 9, wherein two ends of the leveling member are provided with a first locking part and a second locking part respectively, and at least one of the first locking part and the second locking part is locked to the assembly port.

19. The hand-pushed mower according to claim 9, wherein the leveling member is provided with a recess, such that the leveling member is arranged around the supporting part, each of two ends of the leveling member is provided with a via hole corresponding to the assembly port, the shifting plate further comprises a fastener, and the fastener is configured to penetrate the two via holes and the assembly port, such that the leveling member is fixed to the supporting part.

20. The hand-pushed mower according to claim 7, wherein each of two ends of the leveling member is provided with a snap-fitting structure, and the snap-fitting structure is fixed to an edge of the supporting part in a clamping manner.

21. The hand-pushed mower according to claim 8, wherein the leveling member is provided with an accommodating recess and a via hole, the via hole is in communication with the accommodating recess, an end of the supporting part is adaptively accommodated in the accommodating recess, the supporting part is provided with an assembly port, the shifting plate further comprises a fastener, and the fastener is configured to penetrate the via hole and the assembly port to be fixed to the supporting part.

22. The hand-pushed mower according to claim 9, wherein the supporting part is provided with an accommodating recess and the assembly port, the assembly port is in communication with the accommodating recess, an opening of the accommodating recess is located away from the body, the leveling member is accommodated in the accommodating recess, the shifting plate further comprises a fastener, and the fastener is configured to penetrate the assembly port to be fixed to the leveling member.

23. The hand-pushed mower according to claim 6, wherein the shifting plate is made of a hard material.

24. The hand-pushed mower according to claim 23, wherein the shifting plate is made of a metal material.

25. The hand-pushed mower according to claim 6, wherein the leveling member is made of a flexible material.

26. The hand-pushed mower according to claim 25, wherein the flexible material comprises at least one of plastic, silica gel, rubber, teflon, foamed polyurethane, a polyurethane elastomer, or flexible polyurethane.

27. The hand-pushed mower according to claim 6, wherein
the leveling member is of a solid structure;
the leveling member is of a hollow structure; or,
the leveling member is provided with a hollow cavity, and a plurality of supporting columns are arranged at intervals in the hollow cavity.

28. The hand-pushed mower according to claim 6, wherein
the supporting part is detachably connected to the main body part; or,
the supporting part and the main body part are integrally formed.

29. The hand-pushed mower according to claim 6, wherein the leveling member is bonded to the supporting part.

30. The hand-pushed mower according to claim 6, wherein the supporting part is of at least one single shape or a combined shape of an I-shape, a J-shape, an L-shape, a T-shape, a shape of two parallel horizontal bars with a vertical bar across the two parallel horizontal bars, a C-shape, or a U-shape.

31. The hand-pushed mower according to claim 6, wherein one side of the leveling member closer to the ground is of a flat surface, an arc-shaped surface, a trapezoidal surface, or a sharp-pointed structure.

32. The hand-pushed mower according to claim 1, wherein in the upright state, an included angle α between the body and a vertical direction ranges from 0°to 20°.

33. The hand-pushed mower according to claim 1, wherein when the body is in the upright state, the leveling member is in line contact with the ground at any one of the two or more levels.

34. The hand-pushed mower according to claim 1, wherein when the body is in the upright state, the leveling member is in surface contact with the ground at any one of the two or more levels.

35. The hand-pushed mower according to claim 1, wherein a contact position between the leveling member and the ground changes with a change between the two or more levels under an effect of the body height adjusting member.

36. The hand-pushed mower according to claim 1, wherein the supporting part is rotatably connected to the main body part, and the leveling member is located at one side of the supporting part away from the main body part.

37. A hand-pushed mower, comprising:
a body;
a body height adjusting member;
a shifting plate;
a front wheel assembly;
a rear wheel assembly; and
a cutting member;
wherein the rear wheel assembly comprises a rotating shaft and rear wheels arranged in a pair, two ends of the rotating shaft are connected to the rear wheels respectively, the rotating shaft is assembled at the body, the rotating shaft is connected to the body through two assembly points, a line on which a line segment between the two assembly points is located constitutes a first axis, a line on which a line segment between circle centers of the rear wheels is located constitutes a second axis, and the first axis and the second axis are not coaxial;
the body height adjusting member operates at two or more levels, the body height adjusting member is configured to drive the rear wheels to rotate around the first axis so as to adjust a height of the body, the shifting plate is configured to keep the body upright when a holding rod of the body is folded and the body is in a storage state, the shifting plate comprises a main body part and a supporting part, the main body part is connected to the body, and the supporting part is configured to be in direct contact with ground; and
when the body is in an upright state, the rear wheels are tangent to the ground, when the body height adjusting member is at a lowest level, a tangent line of a corresponding one of the rear wheels located at one side of the rear wheels away from the front wheel assembly and passing through a preset point W of the supporting part is L1, when the body height adjusting member is at a highest level, a tangent line of the corresponding rear wheel located at one side of the rear wheels away from the front wheel assembly and passing through the preset point W of the supporting part is L2, and an included angle β between the tangent line L1 and the tangent line L2 is an acute angle.

38. The hand-pushed mower according to claim 37, wherein in the upright state, a line segment constituted by a contact point between the supporting part and the ground and a contact point between the corresponding rear wheel and the ground is L, and a distance between an intersection point of a vertical line on which a center of gravity of the body is located and the line segment L and a midpoint of the line segment L is less than or equal to ±150 mm.

39. The hand-pushed mower according to claim 37, wherein the included angle β is less than or equal to 15°.

40. The hand-pushed mower according to claim 37, wherein
a size of each of the rear wheels is identical to that of a front wheel of the front wheel assembly, and a rotation angle θ of each of the rear wheels satisfies: 90°≤θ≤270°, wherein a distance between the second axis and the first axis is greater than or equal to a vertical distance between a lowest cutting plane of the hand-pushed mower at the highest level of the body height adjusting member and that of the hand-pushed mower at the lowest level of the body height adjusting member; or,
a size of each of the rear wheels is greater than or equal to that of a front wheel of the front wheel assembly, and a rotation angle θ of each of the rear wheels satisfies: 90°<θ<270°, wherein a distance between the second axis and the first axis is greater than a vertical distance between a lowest cutting plane of the hand-pushed mower at the highest level of the body height adjusting member and that of the hand-pushed mower at the lowest level of the body height adjusting member, wherein
the lowest cutting plane is a cutting plane of the cutting member during cutting at the lowest level.

41. The hand-pushed mower according to claim 37, wherein a radius size of each of the rear wheels is 20 mm greater than a distance between the second axis and the first axis.
